(19) United States
(12) Patent Application Publication
(10) Pub. No.: US 2008/0308413 A1
(43) Pub. Date: Dec. 18, 2008

(54) Electrochemical Deposition of Compounds in a Continuous Flow of Liquid

(75) Inventor: Michael Boss, Kobenhavn S. (DK)

Correspondence Address: GIFFORD, KRASS, SPRINKLE,ANDERSON & CITKOWSKI, P.C, PO BOX 7021, TROY, MI, 48007-7021, US

(73) Assignee: Recometa ApS, Denmark (DK)

(21) Appl. No.: 12/158,586

(22) PCT Filed: Dec. 22, 2006
(86) PCT No.: PCT/DK06/00738

§ 371 Date: Aug. 7, 2008

(30) Foreign Application Priority Data
Dec. 22, 2005 (DK) PA 2005 01814

(51) Int. Cl. C25B 9/00; C02F 1/461

(52) U.S. Cl. 204/275.1; 205/742

(57) ABSTRACT

An apparatus for rinsing liquid medium is described, the apparatus is an electrochemical cell comprising an anode with a precious metal and at least one cathode made of a non-metallic support material in the form of fibre positioned to form a mesh or a felted mat. The support material of the cathode is treated with a metal. When the electrochemical cell is in function, compounds and/or particles of a liquid to treat are deposited on the mat(s) functioning as the cathodes. The cathodes are easily replaced e.g. when no more compounds can be deposited on the mat. Pure samples of metals can be obtained by burning away the support material of the cathodes. The electrochemical cell is especially suitable to treat water including process water, waste water, and ground water.

### FIELD OF INVENTION

The present invention relates to an electrochemical method and an electrochemical apparatus for treating a liquid solution, especially water, to remove contaminants, especially metal and heavy metal. The method and apparatus are especially suitable for removing heavy metal from a liquid solution e.g. from water. The invention also relates to recovery of metals and heavy metal obtained from a liquid solution.

### BACKGROUND OF INVENTION

During many commercial operations, wastewater is generated which contains metal and heavy metal contaminants such as silver, chromium, copper, zinc, nickel, lead and cadmium. Also municipal wastewater, groundwater and other kinds of waste water including process water may contain metal or heavy metal which should be removed before discharge.

In any electrochemical cell for treating water or waste water, there are certain very stringent requirements imposed upon the anode and cathode materials. In particular, it is required that the cathode especially exhibit a large reaction surface area.

The cathode material should also be able to withstand high levels of metal loading before exhaustion, so that excessive frequency replacement of the cathode material is not required. Moreover, since at least some electrode replacement is necessary during operation of such treatment systems because of electrodeposition of copper or other metal, the cell should be constructed to allow easy disassembly and replacement of the electrodes.

In the present invention, one or more flow through cathodes of the same or different material is replaceable in a very simple way, thereby allowing a use of the electrochemical cell where only short interruptions in handling the water are needed to replace one or more cathodes.

When the cathodes of the present invention have to be replaced due to a high level of metal deposition, the cathodes removed from the electrochemical cell can be subjected to high temperatures or fire to burn away the cathode material, resulting in a portion of a substantially pure metal.

By the term “burn away” is meant that the support material is treated by a temperature at which the support material is converted into carbon dioxide (CO₂) and water (H₂O), the carbon dioxide and water will evaporate during the burning or heating process. The temperature used can be the melting temperature of the deposited metal, although the support material may be burned away at lower temperatures.

Recovery of metal by electrodeposition on an electrode, which is subsequent burned away, is a method which is economically competitive or much cheaper when compared to other metal recovery methods.

Activated carbon may be used as electrode material. This material has some advantages, but it may be contaminated by bacteria growth. Thus if an electrochemical cell including an electrode made of activated carbon is used for rinsing water and especially for rinsing drinking water, there is a risk that this water is contaminated by the bacteria located in/on the carbon material. The water then needs to be treated before use as drinking water e.g. by ultra-violet (UV) treatment to obtain water of no risk for humans or animals.

The cathodes of the present invention are cheap, and almost pure compounds or metal can be recovered by use of the cathodes.

### SUMMARY OF INVENTION

In a first aspect the present invention relates to a medium treatment apparatus, the apparatus comprising

i. a container with at least one first opening and at least one second opening, where one of the first opening and second opening is positioned in the apparatus to direct medium into the treatment apparatus and the other of the first opening and second opening is positioned in the apparatus to direct medium out of the treatment apparatus,

ii. at least one first electrode comprising a first conductive non-metal material and/or a first metal and the first metal may be surface treated with a precious metal,

iii. at least one second electrode comprising a support material, wherein the support material may be at least partly coated (metallized) with a second metal or the support material may comprise a second conductive non-metal material optionally at least partly coated (metallized) with a second metal, and

iv. wherein the at least one first electrode is located closest to the first opening and the at least one second electrode is located closest to the second opening, and

v. wherein there is an electric potential difference between the at least one first electrode and the at least one second electrode to effect electrochemical deposition on one of the at least one or more first or second electrode.

The invention disclosed further relates to a medium treatment apparatus, where the apparatus comprises i) a container with at least one inlet and at least one outlet, ii) at least one first electrode comprising a first metal and the first metal may be surface treated with a precious metal, iii) at least one second electrode comprising a support material, wherein the support material is at least partly coated or metallized with a second metal, and wherein the at least one first electrode may be located closest to the inlet and the at least one second electrode may be located closest to the outlet, and wherein there is a potential difference between the at least one first electrode and the at least one second electrode to effect electrochemical deposition on one of the at least one first or second electrode.

The treatment apparatus comprises in one embodiment a first plate positioned between the inlet and the at least one first electrode and optionally a second plate positioned between the at least one second electrode and the outlet. The first and/or second plates determines the flow direction of the medium through the apparatus. The flow direction between the first and second plate may be diagonal.

The second electrode comprises a support material which may be made of non-metallic fibre, which may be processed to be in the form of e.g. a felt or mesh. The felt of support material can be metallised with a metal e.g. copper. The felt can be positioned in a frame, which secures easy handling of the second electrodes. The second electrodes can be placed in the apparatus e.g. by entering the frame into grooves made in the walls of the apparatus.

A potential difference is made over the two or more electrodes. When liquid to treat is passed through the apparatus, compounds and/or particles within the liquid are deposited onto one of the electrodes. When the first electrode function as anode and the second electrode(s) function as cathode, the compounds and/or particles e.g. in the form of metal particles are deposited onto the cathode.

When compounds and/or particles are deposited onto a second electrode or cathode in an amount where replacement of the electrode or cathode with a new second electrode or cathode is required, the deposited compounds and/or particles can be recovered by burning away the support material of the electrode or cathode.

### DESCRIPTION OF DRAWINGS

FIG. 1. Side view of an apparatus according to the present invention.

FIG. 2. Top view of an apparatus according to the present invention.

FIG. 3. Amount of water passing through an apparatus according to the present invention with or without a second electrode.

FIG. 4. Top view of a cylinder-shaped apparatus according to the present invention.

### DETAILED DESCRIPTION OF THE INVENTION

In a first aspect the invention relates to a medium treatment apparatus, the apparatus comprising

i) a container with at least one first opening and at least one second opening, where one of the first opening and second opening is positioned in the apparatus to direct medium into the treatment apparatus and the other of the first opening and second opening is positioned in the apparatus to direct medium out of the treatment apparatus,

ii) at least one first electrode comprising a first conductive non-metal material or a first metal and the non-metal material or first metal is optionally surface treated with a precious metal,

iii) at least one second electrode comprising a support material and/or metal, wherein the support material and/or metal can be at least partly coated (metallized) with a second metal or the support material and/or metal comprises a second conductive non-metal material optionally at least partly coated (metallized) with a second metal, and

wherein the at least one first electrode is located closest to the first opening and the at least one second electrode is located closest to the second opening, and

wherein there is a potential difference between the at least one first electrode and the at least one second electrode to effect electrochemical deposition on one of the at least one first or second electrode.

In an embodiment the invention relates to a medium treatment apparatus, the apparatus comprising i) a container with at least one inlet and at least one outlet, ii) at least one first electrode comprising a first metal and the first metal is optionally surface treated with a precious metal, iii) at least one second electrode comprising a support material, wherein the support material can be at least partly coated or metallized with a second metal, and wherein the at least one first electrode is located closest to the inlet and the at least one second electrode is located closest to the outlet, and wherein there is a potential difference between the at least one first electrode and the at least one second electrode to effect electrochemical deposition on one of the at least one first or second electrode.

### The Container

The container can be of any suitable form, preferred is box-shaped or cylindrical.

The container may have any suitable dimension which allow volume for at least one first electrode and at least one second electrode. The electrodes are described elsewhere herein. Preferred is when the container further allows volume for a first and/or a second plate positioned as described elsewhere herein.

A box-shaped container may be of a dimension in each direction. Preferred is when one of the dimensions is less than 20 M, such as less than 15 M, e.g. less than 10 M, such as less than 7 M, e.g. less than 6 M, such as less than 5 M, e.g. less than 4 M, such as less than 3 M, e.g. less than 2 M, such as less than 1 M, e.g. less than 0.5 M.

Each dimension of the container may be any suitable. Examples of the dimensions are between 10 cm and 200 cM.

A cylindrical container may be of a dimension in each direction of between 5 cm and 20 m, e.g. between 5 cm and 15 m, such as between 5 cm and 10 m, e.g. between 5 cm and 5 m, such as between 10 cm and 4 m, e.g. between 10 cm and 3 m, such as between 10 cm and 2 m, e.g. between 10 cm and 1 m, such as between 10 cm and 0.5 m.

The dimensions of the container can be any dimension, which in combination with the selected flow velocity of the liquid allow the liquid to have a retention time within the material of the first and/or second electrode of at least 0.1 sec, such as at least 0.2 sec, e.g. at least 0.3 sec, such as at least 0.4 sec, e.g. at least 0.5 sec, such as at least 0.6 sec, e.g. at least 0.7 sec, such as at least 0.8 sec, e.g. at least 0.9 sec, such as at least 1 sec.

Especially when the liquid is passing the fiber material described elsewhere herein, the mentioned retention time is important. The retention time within the fiber material may be as short as possible, the retention time may be between 0.1 sec and 60 sec, such as between 0.2 sec and 50 sec, e.g. between 0.3 sec and 40 sec, such as between 0.4 sec and 30 sec, e.g. between 0.5 sec and 20 sec, such as between 0.6 sec and 10 sec, e.g. between 0.7 sec and 5 sec, such as between 0.8 sec and 4 sec, e.g. between 0.9 sec and 3 sec, such as between 1 sec and 2 sec.

The retention time mentioned above can be the retention time within a fibre material of about 0.5 cm.

The retention time of the compounds to deposit within a fibre material may also be much more than described above, retention times may be e.g. from 1 min to 2 hours, such as 2 min to 1.5 hours, e.g. 3 min to 1 hour, such as 5 min to 45 min.

The retention time is determined by the velocity of the liquid passing through the apparatus. With a second electrode of 1 M² (e.g. a frame of about 100 * 100 cm) and a velocity of 10 cM per hour at least 100 L of liquid can be treated per hour. The second electrode may be between e.g. 0.5 to 20 cm in this example, such as 10 cm.

The flow velocity of the liquid can be any possible allowing the retention time as specified above. The flow velocity may be calculated as the volume of liquid passing the electrodes within a time unit, hereby the flow velocity may be between 0.01 and 20 m/h, such as between 0.3 and 15 m/h, e.g. between 0.5 and 10 m/h, such as between 1 and 8 m/h, e.g. between 4 and 6 m/h, also flow velocity between 0.02 and 5 m/h can be used, e.g. between 0.03 and 4 m/h, such as between 0.05 and 3 m/h.

The flow velocity through the apparatus of the liquid may be regulated such that the water flow through the apparatus is approximate a uniform stream. The stream can be parallel to the bottom of the container or it can be e.g. diagonal. The stream direction can be determined by the first and/or second plate and the features of these plates. The plates are described elsewhere herein.

The container may be of any suitable material, which is able to support the electrodes and other features of the apparatus, and which is able to withhold the medium that is to be directed through the container inside of the container. A suitable material may be one which in not electrically conductive. If the material is not able by itself to withhold the medium inside of the container, an outer frame of any suitable material may support the container material and/or the material of the container may be reinforced with another material.

Preferred materials from which the container is manufactured are polymers, e.g. polyolefins.

Preferred is when the bottom and walls of the container are moulded into one piece of polymers e.g. of PE (polyethylene) and/or PP (polypropylene).

The container may have a lid, which can be of the same material as the rest of the container.

### Inlet and Outlet

The container comprises at least a first opening and at least a second opening, where one of the first opening and second opening can be positioned in the apparatus to direct medium into the treatment apparatus and the other of the first opening and second opening can be positioned in the apparatus to direct medium out of the treatment apparatus.

The at least one first opening and at least one second opening can be either an inlet and an outlet or opposite. The at least one first opening may be located closest to the first electrode, then the at least one second opening is located closest to the second electrode. Also the at least one first opening may be located closest to the second electrode, then the at least one second opening is located closest to the first electrode.

The flow of the medium through the container may thus be in a direction where the medium first passes the first electrode and then passes the second electrode. Also the medium flow through the container may be reversed thus the medium first passes the second electrode and then passes the first electrode.

In a preferred embodiment the at least first opening is at least one inlet, and the at least second opening is at least one outlet. However, where inlet and outlet are described elsewhere herein these terms can be exchanged by each other and comprises embodiments where the flow direction is in the opposite direction.

The container comprises at least one inlet and at least one outlet. The inlet and outlet may be positioned in any suitable location of the container allowing a medium to enter the container, passing the at least one first electrode, the at least one second electrode and leaving the container through the outlet.

The inlet and/or outlet may be positioned in the upper part of the container, this being in the lid or the upper half part of the wall or in the lower part of the container, this being in the bottom or the lower half part of the wall. Preferred is when the inlet is positioned in the upper part of the container, and the outlet is positioned in the lower part of the container. Further preferred is when the inlet is positioned in the upper half part of the wall and the outlet is positioned in the lower half part of the wall. Also preferred is when the outlet is positioned in the wall close to the bottom of the container, e.g. within 20 cm from the bottom of the container, such as within 15 cm from the bottom of the container or within 10 cm from the bottom of the container.

The cross section dimensions of the inlet and outlet may be of any suitable dimensions to allow a medium to enter the container, passing the at least one first electrode, the at least one second electrode and leaving the container through the outlet. The dimensions of the inlet and outlet are determined in accordance to the dimensions of the container, the flow velocity and the retention time of the liquid within the first and/or second electrode. The total dimensions of the inlet and/or outlet may be between 0.5 cm² and 1000 cm², such as between 1 cm² and 500 cm², e.g. between 2 cm² and 250 cm², such as between 3 cm² and 200 cm², e.g. between 4 cm² and 100 cm², such as between 4.5 cm² and 50 cm²., e.g. between 4.5 cm² and 25 cm², such as between 4.5 cm² and 15 cm²., e.g. between 4.5 cm² and 10 cm².

The dimensions of the inlet and outlet may be selected such that these are substantially equal, or the outlet may be larger than the inlet.

### First and Second Plate

In an embodiment the medium treatment apparatus comprises a first plate which may be positioned between the inlet of the container and the at least one first electrode.

Also the first plate may be positioned to obtain a distance between the lower part of the first plate and the bottom of the container or between the upper part of the first plate and the top of the container. Preferred is to obtain a distance between the lower part of the first plate and the bottom of the container.

In another embodiment the medium treatment apparatus comprises a second plate which is positioned between the at least second electrode and the outlet of the container.

The liquid to be treated can bypass the first and/or second plate in the area between the bottom of the container and the first and/or second plate and/or the area between the top of the container and the first and/or second plante.

Preferred is when the medium treatment apparatus comprises at least one of the first or second plate. More preferred is when the apparatus comprises both a first and a second plate.

In another embodiment one of the first or second plate may be positioned between the first and second electrode.

The first and/or second plate may be connected to the container in a way which allows increasing or decreasing the distance between the plate and the bottom of the container and/or between the plate and the top of the container. Preferred is when the distance from the first plate to the top or bottom of the container and the distance from the second plate to top or bottom of the the container are located in the opposite positions of the first and second plate e.g. at the bottom of the first plate and at the top at the second plate. More preferred is when there is a distance between the lower part of the first plate and the bottom of the container together with a distance between the upper part of the second plate and the top of the container.

The first and/or second plate may be simple plates without perforations, or the plates may be with perforations. Two or more plates with perforations can be placed close together to constitute a first or a second plate. One or both of these two plates can be moved such that the perforations overlap more or less and hereby determines the amount of media which can pass the two or more plates placed close together.

The perforations may have a closing mechanism similar to the closing mechanism of a camera objective.

The plates with perforations may or may not be adjustable in relation to obtaining a distance from the plates to the top and/or bottom of the container to obtain a medium flow beneath or above the plates as described above.

The total area of the perforations or of the area beneath or above the plates may be determined in accordance with the desired flow velocity of the medium through the container.

In a preferred embodiment the total area of the perforations or of the area beneath or above the plates may be similar to the total area of the first and/or second opening which constitute the inlet and outlet (or outlet and inlet). The area of the first and/or second opening is described elsewhere herein, and is also valid for the area of the perforations or of the area beneath or above the plates.

The second plate may be horizontal at the upper part of the plate, or it may have cut outs in part of the plate, e.g. the upper part of the second plate is like a zig-zag line.

The distance between the first plate and the container as well as the distance between the second plate and the top or bottom of the container may be varied between 0.5 cm and 100 cm, such as between 1 cm and 90 cm, e.g. between 2 cm and 80 cm, such as between 3 cm and 70 cm, e.g. between 4 cm and 60 cm, such as between 5 cm and 50 cm, e.g. between 6 cm and 40 cm, such as between 7 cm and 30 cm, e.g. between 8 cm and 20 cm, such as between 9 cm and 15 cm.

Preferred is a distance between the first plate and the container and a distance between the second plate and the top or bottom of the container, which at the flow velocity used do not cause turbulence in the liquid media passing through the container.

The first and second plate may be of any suitable material which is not a conductive material. The material may be made of any material which can also be used to produce the container. The first and/or second plate used within a container may be of the same material or another material used for the manufacturing of the container it self.

### Grooves

The container may have fixing means which keep the electrodes as described elsewhere herein and optionally the first and/or second plate as described below in the correct positions within the container.

In a box-shaped container the fixing means may be in the form of grooves into which the electrodes and/or first and/or second plate can be inserted. The grooves and the electrodes and/or first and/or second plate have to fit tightly in a way that no or substantially no medium can bypass the first electrode and/or second electrode and/or first plate and/or second plate within these grooves.

The dimensions or form of the grooves and of the part of the electrodes or plates which are to be positioned into the grooves may be selected to ensure a simple movement of the electrodes or plates within the grooves, and thus in and out of the container.

The container may comprise at least two set of grooves, one for a first electrode and one for a second electrode.

A set of grooves is two grooves positioned in opposite walls of the box-like container to fix an electrode or a plate in a proper position. Also a groove connecting two grooves in each side of the container may be located in the bottom of the box-like container.

Preferred is when the container comprises at least four set of grooves, two for the electrodes and two for the plates. Also preferred is when the container comprises at least three set of grooves for the electrodes, one set of a groove for the first electrode and two sets of grooves for the second electrodes. Further preferred is when the container comprises at least six set of grooves for the electrodes, this may be one set of a groove for the first electrode and five sets of grooves for the second electrodes.

The container may comprise at least one set of grooves for the second electrodes, e.g. at least two sets of grooves, such as at least three sets of grooves, e.g. at least four sets of grooves, such as at five sets of grooves, e.g. at least six sets of grooves, such as at least seven sets of grooves.

The number of grooves may be any between 0 and 100, such as between 1 and 50, e.g. between 2 and 25, such as between 3 and 20, e.g. between 4 and 15, such as between 5 and 15, e.g. between 6 and 15, such as between 7 and 15, e.g. between 8 and 15, such as between 9 and 15, e.g. between 10 and 15.

The distance between two of the grooves may be any distance, but when first and/or second electrodes are inserted into the grooves, these electrodes may not be in contact with each other. The distance between two grooves measured from the central part of each groove may be between 0.5 cm and 50 cm, such as between 1 cm and 40 cm, e.g. between 1.5 cm and 30, such as between 2 cm and 20 cm, e.g. between 3 cm and 15, such as between 4 cm and 10 cm, e.g. between 5 cm and 10, such as between 6 cm and 10 cm, e.g. between 7 cm and 10, such as between 8 cm and 10 cm, e.g. between 9 cm and 10 cm.

In some situations it may be beneficial to create a contact between two or more second electrodes hereby short-circuit the electrodes.

The distance from one or more grooves where one or more first electrodes can be inserted to one or more grooves where one or more second electrodes can be inserted may be larger than the distance between the grooves used for the first electrodes and the grooves used for the second electrodes.

The grooves can be used for insertion of electrodes and/or plates into the container, thus a number of grooves may be situated along the container. The number of grooves and the distance between two grooves located next to each other may be any one as described above. Preferred is when the distance between two grooves is selected between 2, 2.5, 3, 3.5, 4, 4.5, 5, 5.5, 6, 6.5, 7, 7.5, 8, 8.5, 9, 9.5, and 10 cm measured from the central part of each groove. This distance may vary between different grooves, or the same distance may be used throughout the container.

### The First Electrode

The first electrode can be made of a first metal or an alloy, which is highly resistant to oxidation and corrosion. The metal may be selected from, but is not limited to the group of metals with the symbols Al, Zn, Fe, Sn, Pb, Cu, Ag, Pt, Ti. Preferred is the metal titanium, aluminum, steel, platinum.

The first metal may also be a conductive non-metal material which may be selected from the group of ceramic materials, non-conductive polymers and conductive polymers e.g. PANI.

The first electrode can also be made of a conductive ceramic material. A conductive ceramic material may contain elements from the lanthanides or actinides. A conductive ceramic material may also be ceramic titanium.

In a preferred embodiment the first electrode is made of titanium. In a further preferred embodiment the first electrode is made of platinum. The preferred first electrode may be in the form of bars and/or wire/fiber.

The first electrode made of a first metal may be surface treated with a second metal. The second metal may be more noble than the first metal or than the alloy. The order of less noble metals to more noble metals are:

Al, Zn, Fe, Sn, Pb, Cu, Ag, Pt, Ti.
Less noble → → → → More noble

The metal Au is less preferred as this metal has a low conductivity.

The second metal may be a precious metal, and may be selected from, but is not limited to the group of platinum and gold. Preferred is when the second metal is Pt.

Without the surface treatment with the second metal, the first electrode may depending on the material used be destroyed by electrolysis when the apparatus is in function.

In a more preferred embodiment the first electrode is made of titanium coated with platinum. The coating improves the lifetime of the first electrode. The thickness of the platinum coating is between 0.01 micrometer and 50 micrometer, such as between 0.05 and 40 micrometer, such as between 0.1 and 30 micrometer, such as between 0.25 and 20 micrometer, such as between 0.5 and 15 micrometer, such as between 0.75 and 10 micrometer, such as between 1 and 5 micrometer, such as between 2 and 4 micrometer, such as between 2.5 and 3.5 micrometer, such as between 2.8 and 3.2 micrometer. Preferred is about 3 micrometer.

Depending on the thickness of the platinum coating and the time the first electrode is used, the anode may have a lifetime of 1-2 years or even longer.

In a further preferred embodiment the first electrode is made of titanium coated with platinum. After the first electrode is coated with platinum the first electrode can be heated in an inert atmosphere at about 770-790 degree Celsius for about an 0.5-1 hour. This heating further improves the lifetime of the first electrode, which can be up to 10 years or even longer.

The first electrode may also be made purely of platinum. This electrode may be heat treated as described above.

The first electrode may be made of bars of the material described above. Depending on the dimension of the treatment apparatus, one bar may be suitable as the first electrode. Two or more bars may also be used. A row of bars is understood as one first electrode. This row of bars may have any suitable overall form, being e.g. linear, circular or spiral.

The number of bars within a first electrode may be any suitable between 1 and 100, such as between 2 and 50, e.g. between 2 and 40, such as between 2 and 30, e.g. between 2 and 25 such as between 2 and 20, e.g. between 2 and 15 such as between 2 and 10, the lower number in these intervals may also be 3, 4, 5, 6, 7, 8, 9, 10, 11, 14, 15.

The number of bars within a first electrode may be calculated as number of bars per meter, and can be between 2 and 100, such as between 5 and 90, e.g between 10 and 80, such as between 15 and 70, e.g between 20 and 60, such as between 25 and 50, e.g between 30 and 40.

The distance between the bars within a first electrode may be any suitable. This distance when measured from the middle of one bar to the middle of the next bar can be about 0.5 cm,1 cm, 1.5cm, 2cm, 2.5cm, 3cm, 3.5cm, 4cm, 4.5cm, 5cm, 5.5 cm, 6 cm, 6.5 cm, 7 cm, 7.5 cm, 8 cm, 8.5 cm, 9 cm, 9.5 cm, 10 cm. Preferred is when the distance between each bar in a first electrode is lesser than the distance between the first electrode and the second electrode.

The bars of the first electrode may have any form when seen in a cross-section e.g. circular, ellipse, square or triangular.

The thickness of the bars of the first electrode may be any suitable. By thickness is meant the distance the medium has to pass when the first electrode is inserted into a squared container and the flow direction of the medium is parallel to a vertical bottom. The thickness of the bars may be between 0.01 cm and 10 cm, such as between 0.03 and 5 cm, e.g. between 0.05 cm and 4 cm, such as between 0.07 and 3 cm, e.g. between 0.09 cm and 2 cm, such as between 0.1 and 1 cm, e.g. between 0.15 cm and 0.8 cm, such as between 0.2 and 0.7 cm, e.g. between 0.25 cm and 0.6 cm, such as between 0.3 and 0.5 cm, e.g. between 0.35 cm and 0.4 cm.

The thickness is also determined according to the stiffness of the metal. Thin bars can be made with stiff metal.

The bars of the first electrode may be oriented in any direction. Preferred is when the bars are in diagonal, horizontal or vertical orientation within the container. More preferred is horizontal or vertical orientation. Most preferred is vertical orientation.

The number of bars within one first electrode depends on the dimension of the container. The distance between the bars are determined in accordance to the thickness of the bars as described elsewhere herein. The number of bars within one first electrode is thus determined by the dimension of the container, and the number may be as described elsewhere herein.

The first electrode may be connected to a frame. The frame comprises at least one cross bar, which keeps the bars of the first electrode in the proper orientation within the container. A cross bar may be located in each end of the bars of the first electrode. The ends of the cross bars may be constructed to fit into the grooves of the container, the grooves are described elsewhere herein.

The first electrode can also be in the form of one or more wires, threads and/or fibres of the material described herein e.g. of platinum.

The first electrode may be mounted in a frame. The frame ensures easy handling of the first electrode when this is inserted or removed from the container of the treatment apparatus. The frame may be constructed of the same material as can be used in the production of the container. These materials are described elsewhere hererin.

The frame may be a single-sided or double-sided frame. In the case of a single-sided frame the electrode material is mounted directly on this frame. In the case of a double-sided frame the electrode material is mounted on one of the frames and the other frame is positioned on the side of the electrode material not connected to a frame. The double-sided frame may consist of two parts, which are connected so that the frame can be opened, the electrode material can be placed within the frame, the frame can be closed, and the frame including the electrode material is ready to insert into the container of the apparatus.

The first electrode mounted on a frame may be in the form of substantially parallel threads/wires or a fabric of the electrode material. A distance between the substantially parallel threads/wires may be any distance between 0.1 and 10 cm, e.g. about 1, 2, 3, 4, 5, 6, 7, 8, 9 cm.

The diameter of the threads/wires used as the first electrode material and optionally further weaved into a fabric, may be any suitable, e.g. a diameter of between 10 μM and 5 MM, although the larger dimensions within this range may also be considered as a bar as described elsewhere herein. A suitable diameter of a wire may be 0.01 MM to 1 MM, such as 0.1 MM to 0.9 MM, e.g. 0.2 to 0.8 MM, such as 0,5 MM to 0.7 MM. The wire may be of platinum.

In a preferred embodiment the first electrode is an anode.

### The Second Electrode

The second electrode comprises a support material which may be made of at least one non-metallic fibre or a ceramic material.

The second electrode may also comprise a second conductive non-metal material. The conductive non-metal material may be selected from the group of ceramic materials, non-conductive polymers and conductive polymers e.g. PANI.

The at least one non-metallic fibre may be at least one polymer. Examples of polymers can be PE (polyethylene) and PP (polypropylene).

The fibres of the second electrode may each have a diameter between 0.01 and 1 mm, such as between 0.015 and 0.8 mm, e.g. between 0.02 and 0.7 mm, such as between 0.025 and 0.6 mm, e.g. between 0.03 and 0.5 mm, such as between 0.035 and 0.4 mm, e.g. between 0.04 and 0.3 mm, such as between 0.045 and 0.2 mm, e.g. between 0.05 and 0.1 mm.

The fibres making up the support material of the second electrode may be attached to each other in any configuration. A preferred configuration is in the form of a mat or as a fabric. In a mat or fabric the fibres may be connected by any suitable method e.g. felted, meshed, woven, knitted. Preferred is a felted mat and a woven fabric. More preferred is a felted mat.

The thickness of a single second electrode is dependent on the porosity of the mat. Increasing thickness of the mat may increases the resistance to the medium flow and thus result in a pressure drop of the medium flow. For some medium the thickness of the mat need not result in a pressure drop, although this depends on the porosity of the mat.

The porosity of the second electrode should be large, that is in excess of 50%, such as in excess of 60%, e.g. in excess of 65%, such as in excess of 70%, e.g. in excess of 75%, such as in excess of 80%, e.g. in excess of 85%, such as in excess of 90%, e.g. in excess of 95%,) to minimize flow restriction. The porosity is calculated as percent of air (in dry conditions) or liquid (in wet conditions) within the total volume of the cathode(s). The total volume is the volume within two walls each located on one side of the electrode. Thus if the second electrodes are manufactured as bars, the space between the bars is included when calculating the porosity.

At a porosity of 20-80%, the second electrode can have a thickness of from about 0.05 to about 10 cm, such as from about 0.1 to about 9 cm, such as from about 0.2 to about 8 cm, such as from about 0.3 to about 7 cm, such as from about 0.4 to about 6 cm, such as from about 0.5 to about 5 cm, such as from about 0.6 to about 4 cm, such as from about 0.7 to about 3 cm, such as from about 0.8 to about 2 cm.

Preferred is a thickness of the mat of the second electrode of about 0.1 to about 3 cm, more preferred is a thickness of about 0.2 to about 2 cm. Yet further preferred is a thickness of about 0.3 to 1 cm. Most preferred is a thickness of about 0.5 cm.

Also preferred is a thickness of the mat of the second electrode of about 2 to about 30 cm, more preferred is a thickness of about 5 to about 25 cm. Yet further preferred is a thickness of about 10 to 20 cm. Most preferred is a thickness of about 15 cm.

At a porosity of 20-80%, the second electrode can also have a thickness of from about 1 to about 100 cm, such as less than about 90 cm, such as less than about 80 cm, such as less than about 70 cm, such as less than about 60 cm, such as less than about 50 cm, such as less than about 40 cm, such as less than about 30 cm, such as less than about 20 cm. Preferred is a thickness of 10-30 cm. More preferred is a thickness of 15-25 cm.

An example of sizes of a mat is 40-60 cm in length, 40-60 cm in width, and a thickness of about 20 cm. Each fibre of the mat may have a thickness of between 0.001 and 1 mm, such as between 0.005 to 0.5 mm, e.g. between 0.008 to 0.3 mm, such as between 0.009 to 0.2 mm, e.g. between 0.01 to 0.1 mm, such as between 0.02 and 0.09 mm, e.g. between 0.03 to 0.08 mm, such as between 0.04 and 0.07 mm, e.g. between 0.05 to 0.06 mm.

The mat or fabric making up the support material of the second electrode may be in the form of one or more layers of the mat or fabric. The layers of mat or fabric may be 1-10, such as 10, e.g. 9, such as 8, e.g. 7, such as 6, e.g. 5, such as 4, e.g. 3, such as 2, e.g. 1. Preferred is 1-5 layers, more preferred is 1-3 layers, most preferred is 1 layer.

The terms “felt” and “mesh” are used to describe a compressed, non-woven fibrous mass.

The fiber length employed in a fiber mat may range from about 0.01 times the length of the overall thickness of the second electrode to about 100 times or even more of this dimension. This means that each fiber may be folded back upon itself within the fiber mat. Examples of fiber length is between 0.5 to 25 cm, e.g. between 5 to 8 cm.

The fiber length in a fiber fabric may range from about 0.1 times the length of the overall thickness of the second electrode to the entire length of the height or width of the second electrode. The fibers making up the fabric may be single stranded or may be connected e.g. spun into strands of from two to multiple fibers.

The fiber mat used as the second electrode can have a large surface area of the fibers, this can be a surface area of 0.1-100 M² per gram of fiber. Preferred is 0.2-50 M² per gram of fiber. More preferred is 0.3-25 M² per gram of fiber. Even more preferred is 0.4-20 M² per gram of fiber. Further preferred is 0.5-10 M² per gram of fiber. Also preferred is 0.6-5 M² per gram of fiber. Yet further preferred is 0.7-4 M² per gram of fiber. More preferred is 1-3 M² per gram of fiber. Preferred is also about 2 M² per gram of fiber.

A fabric or fiber mat may be made of any material that can be burned away at a temperature lower than the melting point of the metals which are to be deposited. The fabric may be made of natural fibers or synthetic fibers. Non-limiting examples of such fibers are silk, wool, cotton, flax, straw from e.g. grain plants or other plant parts, polymers e.g. selected from nylon, polyolefines. An example of polymer is metallized syntepon.

The second electrode constructed as a mat has a high internal surface area to volume ratio.

The support material of the second electrode may be metallized to be electrically conductive. If the support material by itself is electrically conductive the support material need not be metallized, although the metallization may increase the electrically conductivity and improve the strength of the electrode when compared to electrodes made of carbonised fibre. Carbonised fibre are brittle if they are produced to have a large surface area i.e. if the fibre are porous, the metallization thus improve the strength of the fibre. If the support material itself is not electrically conductive, it has to be at least partly metallized.

In the production of carbonised fibre material a production of micro needles may be produced. These needles are harmful to animals and humans as the needles can be absorbed by the organism and provide e.g. cancer. Thus an electrode which should be used for cleaning drinking water should be produced of carbonised fibre which are metallized as described elsewhere herein.

The support material can be metallized by spraying metal onto the support material of the mat or fabric. Another method is to dip the mat or fabric into a liquid metal. Methods of metallizing a material is know by the person skilled in the art, these methods can be utilized to metallize the support material of the second electrode.

The materials used to metallize the support material of the second electrode can be selected from a metal. Examples of metals are silver, cobber and nickel. Preferred is cobber.

The thickness of the metal on the support material may be between 0.001 μm and 100 μm, such as between 0.005 μm and 50 μm, e.g. between 0.01 μm and 25 μm, such as between 0.02 and 20 μm, e.g. between 0.05 and 15 μm, such as between 0.1 and 12 μm, e.g. between 0.5 and 10 μm, such as between 1 and 8 μm, e.g. between 2 and 7 μm, such as between 3 and 6 μm, e.g. between 3 and 5 μm, such as between 3 and 4 μm.

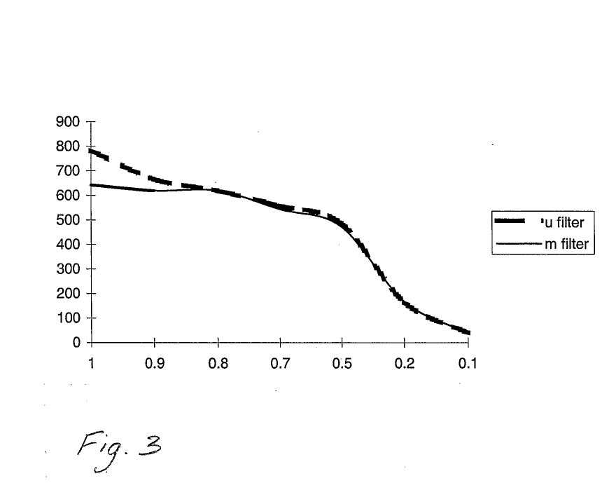

The porous second electrode may have a porosity that allow no or only a small resistance to the flow of the medium to be treated. Hereby no or only a little pressure drop is obtained in the flow of the medium to be treated. Tests have shown that the second electrodes may only result in small pressure drops, see FIG. 3.

The second electrode may be mounted in a frame. The frame ensures easy handling of the electrode when this is inserted or removed from the container of the treatment apparatus. The frame may be constructed of the same material as can be used in the production of the container. These materials are described elsewhere herein.

The frame may be formed to fit into the grooves of the container as described elsewhere herein. The frame ensures that all medium to be treated passes through the electrode material.

The frame may be a single-sided or double-sided frame. In the case of a single-sided frame the electrode material is mounted directly on this frame. In the case of a double-sided frame the electrode material is mounted on one of the frames and the other frame is positioned on the side of the electrode material not connected to a frame. The double-sided frame may consist of two parts, which are connected so that the frame can be opened, the electrode material can be placed within the frame, the frame can be closed, and the frame including the electrode material is ready to insert into the container of the apparatus.

The frame can be reused when a second electrode has to be replaced. Especially the double-sided frame can be reused. The frame can also be burned together with the support material as described elsewhere herein.

The electrical path along the fibers of the second electrode is a path of only low resistance. The mat or fabric composition of the second electrode secures contacts between the fibers and thus only low resistance within the electrode material is observed. High internal resistance in an electrode leads to poor current distribution and will thus decrease the efficiency of the electrode.

The mat construction of the second electrode secures a continuous composition of the second electrode throughout its lifetime. An electrode where the material is not securely connected to each other will have a tendency to settle with time, opening voids and permitting channelling through the electrode and further increase the internal resistance. An electrode of entangled fibers has a far less tendency to settle and will be considerably more stable with time.

The height and width of the second electrode can be any suitable depending on the dimensions of the container of the apparatus as described elsewhere herein.

To ensure a high coefficient of utilization of the material of the second electrode, the support material, which is optionally metallized, may be positioned within the container of the apparatus in a way that the support material is fully or nearly fully within the volume occupied by the liquid media to be treated when the apparatus is in function. Depending on the requirements of the amount of compounds to be removed from at medium to be treated, it may be of importance that the medium to be treated cannot pass the second electrodes without going through the electrodes. Circumventing the second electrodes permits compounds to pass through the treatment apparatus.

The second electrode may be positioned in any position suitable to obtain a flow of contaminated medium through the second electrode. The position may be e.g vertical, horizontal or diagonal. The contaminated medium may enter the second electrode at an angel between 0 and 90 degrees. Preferred is an angel of between 60 and 30 degrees, such as between 55 and 35, e.g. between 50 and 40 degree, such as between 48 and 43, e.g. about 45 degree.

The number of second electrodes within the container of the apparatus may vary from 1 to 50. The number may be lower than 40, e.g. lower than 30, such as lower than 20, e.g. lower than 15, such as lower than 10, e.g. lower than 9, such as lower than 8, e.g. lower than 7, such as lower than 6, e.g. lower than 5, such as lower than 4, e.g. lower than 3, such as lower than 2. Preferred is a number of 1-10. More preferred is 1-8. Most preferred is 1-5.

The number of the second electrodes being positioned after each other in respect to the flow direction of the liquid may be depending on the compounds to be removed from the medium that is treated. Especially it depends on the types of different metals in a contaminated liquid as well as the requirement for purity of the metals deposited on the second electrodes and/or the requirement for the purity of the treated liquid. If a high purity of the metal is to be obtained, the processing features and the second electrodes can be selected to obtain substantially only one metal deposition on each second electrode.

The second electrodes may be similar in construction, but due to their distance to the first electrode, different metal within the liquid to treat deposits on the different second electrodes. Also the second electrodes may be of different construction, hereby different types of metal can deposit on each of the second electrodes. Combinations within the container of second electrodes with different construction may include any second electrodes constructed as described herein.

The total thickness of the second electrodes within the container excluding the volume between the different electrodes may be in the range of from 0.2 cm to 50 cm or even much thicker e.g. 150 cm.

When two or more second electrodes are used in a container and are being positioned after each other in respect to the flow direction of the liquid, the distance between the individual electrodes measured ad the distance between the central part of two parallel electrodes may be between 1 and 100 mm, such as between 10 and 90 mm, such as between 15 and 80 mm, e.g. between 20 and 70 mm, such as between 25 and 60 mm, e.g. between 30 and 55 mm, such as between 35 and 50 mm, e.g. between 20 and 40 mm, such as between 10 and 50 mm.

Normally two or more of the second electrodes which are being positioned after each other in respect to the flow direction of the liquid may not touch each other, thus the distance between two second electrodes may be as little as possible securing no connection between these electrodes. However sometimes the physical connection between two second electrodes may be performed to make a short-circuit.

If two second electrodes which are being positioned after each other in respect to the flow direction of the liquid may not touch each other, the electrodes can have a stiffness by which the medium flow through the electrodes does not change the position of any part of the electrodes. Another possibility is to make the electrodes of a similar stiffness although with some flexibility. Hereby the electrodes may be a little deformed by the force provided by the medium passing through the electrodes, as the electrodes are deformed to the same or to nearly the same degree. The distance between the electrodes can be minimized to the distance where the electrodes do not touch each other when the apparatus is in function.

Also the second electrodes may be positioned in such a way that the front area of the second electrodes where the liquid enters the second electrode is made by two or more second electrodes positioned side by side or on top of each other. If two second electrodes of equal size are positioned side by side, roughly half of the volume to treat will pass through one of these second electrodes, the other half will pass through the other second electrodes. The number of second electrodes positioned side by side or on top of each other can be any number, such as between 2 and 50, e.g. 2, 3, 4, 5, 6, 7, 8, 9, 10, 11, 12, 13, 14, 15, 16, 17, 18 19, 20. The sizes of the second electrodes need not be equal.

The frames with the second electrodes may include fiber material of any suitable dimension. A fiber material of about 400 g may be suitable, also about 500 g, 600 g, 700 g, 800 g, 900 g and 1000 g may be suitable. The weight may be depending on the material to be deposited on the fiber material and thus to the weight of the material when the electrode has to be replaced.

The fiber material of the second electrode needs to be replaced from time to time. The duration of time in which a second electrode can be used in an apparatus before it needs to be replaced depends on the amount of liquid treated per time unit as well as the degree of contaminants within the liquid.

On a second electrode of the type described herein and with a fiber mat weight of about 250 g and e.g. an overall thickness of 0.5 cm, an amount of 0.5 to 50 kg of metal can be deposited on the electrode before it needs to be replaced. The amount of deposited metal can also be between 1 to 45 kg, such as between 2 to 40 kg, e.g. between 3 to 35 kg, such as between 5 to 30 kg, e.g. between 8 to 25 kg, such as between 10 to20 kg, e.g. 11, 12, 13, 14, 15, 16, 17, 18, 19 kg.

The amount of material e.g. metal deposited on the fiber of the second electrode is dependent on a number of factors e.g. of the metal. A metal such as aluminum is a light metal whereas gold is a heavy metal. Thus the density of the metal is of importance. With 100 g of fiber material it may be possible to have an amount of up to 20 kg deposited on the fiber material.

In a preferred embodiment the second electrodes are cathodes.

Depending on the composition of the medium to treat in the apparatus, the second electrodes may also catch particles from the medium, hereby the electrode functions as a filter. To avoid clogging of the electrode by particles before the material of the electrode is filled by depleted compounds, the electrodes may be rinsed to remove the particles. A rinsing process may be by shaking the second electrodes, by washing it down, or by washing it in a counterflow of liquid e.g. water. A counterflow of liquid may be supported by a flow of gas or air through the electrodes.

### Potential Difference

A potential difference is obtained in the apparatus by connecting the first and second electrodes electrically through two conductors, one electrode functions as an anode and at least one electrode function as a cathode. The electrodes are separately connected to a positive and negative power supply, respectively.

The potential is determined by different features such as the voltage of the current and the distance between the first electrode and the second electrode. If more than one second electrode are used in the apparatus different potentials exists over the different second electrodes. The potential and thus the distance from the actual second electrode to the first electrode determines which compounds e.g. which metals are to be deposited.

When operating the apparatus at a voltage below 20V, the distance from the first electrode to the second electrode situated the longest distance from the first electrode, may be about 20 cm, such as about 18 cm, e.g. about 16 cm, such as about 15 cm, e.g. about 14 cm, such as about 13 cm, e.g. about 12 cm, such as about 11 cm, e.g. about 10 cm, such as about 9 cm, e.g. about 8 cm, such as about 7 cm, e.g. about 6 cm.

The apparatus can function with a current between 1 millivolt and 100 Volt.

### The Apparatus

The at least one first electrode and the at least one second electrode function as an anode and cathode depending on the charging of the electrodes when a potential difference is constructed between the electrodes. Anode and cathode are connected electrically through two conductors, which separately are connected to a positive and negative power supply, respectively.

The charging of the at least one first electrode and the at least one second electrode is determined in accordance with the compounds to be deposited on the electrodes.

Preferred is when the at least one first electrode is at least one anode, and the at least one second electrode is at least one cathode.

The potential difference, which are employed in the apparatus, is dependent upon the type of the metal to remove, the concentration of the metal it is desired to remove from the solution, the flow rates employed, and the metal oxidation state.

The volume between the at least one first electrode and the at least one second electrode may be occupied only by the medium to be treated in the apparatus when the apparatus is in function. The first electrode and the second electrode may be built together as a unit. Preferred is that the at least one first electrode and the at least one second electrode are not built together, but can be replaced separately.

The volume between two second electrodes may be occupied only be the medium to be treated in the apparatus when the apparatus is in function. The second electrodes may be built together as a unit. A unit of second electrodes may comprise 2, 3, 4, 5 or 6 second electrodes. Preferred is when the second electrodes are not built together, but can be replaced separately. The second electrodes of a unit may be of similar or different material(s). The material is described elsewhere herein.

The distance between the first and second electrodes may be determined in view of the potential difference of the apparatus. The distance from the at least one first electrode to the at least one second electrode may be between 8 and 12 cm at a working potential of the apparatus below 15 Volt.

Preferred is when the distance between each of the second electrode is between 2 and 6 cm at a working potential of the apparatus below 15 Volt. More preferred is a distance of between 3 and 5 cm. Most preferred is a distance of about 4 cm.

When metal is to be deposited on the second electrode, the metal of the first electrode has to be a more noble metal than the metal to be deposited. The table shows some metals, with the less noble at the left and the more noble metal at the right:

Al, Zn, Fe, Sn, Pb, Cu, Ag, Pt, Ti.
Less noble → → → → More noble

The apparatus as described herein may be employed as a single pass system, or the stream may be recycled until the desired amount of impurities has been removed. Also a number of the apparatus can be placed in succession. Different features of each of the apparatus e.g. different potential and/or different material of second electrodes may improve the removal of heavy metals.

The charging of the metallised second electrode material measured by the surface area, will change if the water surface is changed and not all of the fiber material is covered by the liquid. Preferred is when the second electrodes are entirely covered by the liquid.

When two or more heavy metals are present in the same waste water stream, the optimum conditions for depositions will often be different for the different ions. The present invention provides opportunities for removal of a plurality of heavy metals in a single waste water stream. A plurality of cathodes can be incorporated in one or more containers and the heavy metals can be deposited at different cathodes. Herby the heavy metals are easily separated from each other.

When the metal deposition is completed, which can be determined by the resistance of the material of the second electrode, the second electrode is removed from the container, and another second electrode can immediately be inserted into the container. When a second electrode is replaced, the apparatus may or may not be emptied before this replacement is performed, or a shutter may be placed in front of the second electrode before this second electrode is removed. In case the apparatus is not emptied before replacement of a second electrode, or a shutter is not used, a small amount of contaminants may pass through the apparatus. This amount of contaminants passing through the apparatus is limited by turning off the water flow before replacing the second electrode.

In a preferred embodiment the electrolytic apparatus comprises

a. a liquid containing means having liquid inlet means and liquid outlet means,

b. an anode,

c. at least one cathode comprising conductive fibers which is optionally metallized,
where the anode and cathode are spaced apart and the volume is only occupied with liquid to be treated, and

d. electrical means connected to the anode and cathode for passage of a direct current between the anode and cathode.

In another preferred embodiment the electrolytic apparatus comprises

a. a liquid containing means having liquid inlet means and liquid outlet means,

b. a first plate positioned between the inlet and

c. an anode,

d. at least one cathode comprising conductive fibers which is optionally metallized,
where the anode and cathode are spaced apart and the volume is only occupied with liquid to be treated,

e. a second plate positioned between the at least one cathode and the outlet, and

f. electrical means connected to the anode and cathode for passage of a direct current between the anode and cathode.

The apparatus may further include one or more alarm systems which signal when one or more second electrodes have to be replaced and/or if a leak arises in one of the second electrodes. The alarm may be a reference electrode measuring the conductance of the liquid that has passed the second electrodes.

The alarm may respond to a conductance above a first conductance threshold, to indicate that second electrodes have to be replaced or to indicate a leak in one or more second electrodes or another disfunction giving rise to an increased conductance of the liquid flowing through the apparatus. The alarm may also interrupt the apparatus above a second conductance threshold.

An alarm may respond to a liquid flow beneath a first threshold flow to indicate second electrodes have to be replaced, also the alarm may respond to a flow above a second threshold flow to indicate a leak in one or more second electrodes or another disfunction giving rise to an increased liquid flow through the apparatus. The alarm system may interrupt the apparatus in case the liquid flow is below a first threshold or a third threshold, where the third threshold is lower than the first threshold. The alarm system may also interrupt the apparatus in case the liquid flow is above a second threshold or a fourth threshold, where the level of the fourth threshold is above the level of the the second threshold.

### Media to Treat in the Apparatus

The media which can be treated in the treatment apparatus as described herein can be any fluid or liquid material. Thus if a material is not a liquid at room temperature, the treatment apparatus can be heated to a temperature where the material becomes liquid.

The medium to be treated in the apparatus can be a liquid. The liquid may be selected from, but is not limited to the group of water, organic solutions such as benzene, toluene and xylene.

The compounds to be removed from the media are any compound which can be obtained by electrodeposition. The compounds can be selected from, but is not limited to metals.

The metal to be removed from a liquid by the invention described herein is selected from, but is not limited to the group consisting of elements with atomic numbers 21-30, 39-51, 57-84 and 89-117. Also the elements with the atomic numbers 5, 12, 13, 14, 16, 20, 32, 33, 34, 38, 50, 52, 56, and 88 can be deposited in an apparatus as described elsewhere herein. Preferred is deposition of elements with the atomic numbers 13, 29, 47, 79, 46 and 78. Also preferred is deposition of elements with the atomic number 30 as this element occurs in large amounts.

The media to treat may be a process water e.g. from the industry, waste water from industry or households. Other types of water may be ground water or other water types obtained from nature e.g. sea water, river water etc. Also discharge water from waste-pipes and leachate from roads or dumping grounds can be treated in the apparatus described herein.

### Method of Treating Media

The apparatus as described herein above can be utilized to treat a medium where some compounds are to be and/or are e.g. partly removed from the medium. Also the apparatus can be used in a method of recovering compounds e.g. metal.

An aspect of the invention is a process for treating a medium, the process comprising

i. providing a quantity or a continuous flow of a medium to be treated, the medium includes particles and/or compounds to be removed partly or fully from the medium,

ii. directing an amount of the medium to be treated to a treatment apparatus as described herein above,

iii. directing the medium past at least one first electrode,

iv. directing the medium past at least one second electrode, where a potential difference is established between the at least one first electrode and the at least one second electrode, and where the particles and/or compounds will bind to the at least one first electrode or the at least one second electrode hereby obtaining treated medium when the medium has passed the at least one second electrode,

v. directing the treated medium to an outlet of the apparatus.

In another aspect the invention is a process for treating a medium and recovering particles and/or compounds, the process comprising

i. providing a medium to be treated, the medium includes particles and/or compounds to be removed partly or fully from the medium,

ii. directing the medium to be treated through an electrochemical cell, by first directing the medium through at least one first electrode, and then directing the medium past at least one second electrode,

iii. maintaining a potential difference between the at least one first electrode and the at least one second electrode to effect electrochemical deposition of the particles and/or compounds on the at least one second electrode,

iv. recovering a solution partly or fully released from the particles and/or compounds, and

v. obtaining at least one second electrode with deposited particles and/or compounds, and

vi. recovering the deposited particles and/or compounds by heating the at least one second electrode to a temperature where the at least one second electrode burn away.

The features of the apparatus described in the methods herein, may be any of the features described elsewhere herein.

A continuous flow of medium is preferred, although this is dependent on the volume of medium to be treated. Where batches of media is treated, a non-continuous flow is observed. Batches of media can be obtained e.g. from batch processes e.g. of the industry or in the case of waste water from industry or households or rain water. All other kinds of polluted water can also be treated in a continuous flow or a non-continuous flow in the apparatus described herein.

The medium to be treated can be directed through an apparatus described herein above, where the apparatus contains no, one or two of the first and second plates. In the case of one first and one second plate, one possibility is that the first plate directs the media beneath the first plate and the second plate directs the media above the second plate. Hereby an overall diagonal direction of the medium flow is obtained. The second plate can also be used only to secure the container is not emptied for a liquid medium.

In a preferred embodiment a stream of liquid, containing the metal ions which it is desired to remove, is forced through the cathode while a direct current is passing through the apparatus. Metal ion reduction occurs at the cathode and the metal is deposited on the fibers of the cathode. The deposited metal can be recovered as described elsewhere herein.

The flow through the electrochemical cell of the liquid to be treated can be in any direction, hereby the liquid can pass the anode before the cathode or pass the cathode before the anode. Preferred is when the liquid passes the anode before the cathode.

Also the liquid may enter the apparatus between the first electrode and the second electrode.

The second electrode constructed as a mat has a high internal surface area to volume ratio and the number of intersecting flow channels within it provide turbulent mixing within the second electrode, hereby improving the possibility of a metal ion or particle being located close to the cathode fibers. The metal ions need to be positioned within a certain distance from a fiber to become deposited onto the fiber.

The second electrode is a flow-through porous electrode.

The flow rate of the medium to be treated is adjusted in respect to the compounds to be depositioned onto the second electrode. Some compounds may need a longer retention time of the medium within the second electrode before the compounds have been deposited onto the second electrode. Some metals may need longer time than other metals to pick up electrons and become depositioned as a neutral metal on the second electrode.

By using two or more cathodes, different types of metal of the medium to be treated can be selectively deposited each on one of the second electrodes.

The potential difference between the first and second electrode may be selected between 1 V and 20 V at a distance between the first electrode and the second electrode of less than 30 cm.

The method described is an efficient method as 0,5-9 m³ of medium can be treated per hour in an apparatus of 0.2 m³ (e.g. 75*63*44 cm as length*width*height).

When one or more of the second electrodes are saturated with metal to deposit, the electrodes can be removed and the fiber material of the electrodes can be burned away. There is no requirement for chemical regeneration of the cathode as the deposited metal is obtained with only small amounts of the metal used to metallize the fibre when the fibre material is burned away. The deposited metal and the metal used to metallize the fibre can be recovered by melting. The support material optionally including the frame of the second electrode can be burned away by exposing the second electrode to a temperature e.g. of the melting point of the deposited metal.

### Pre-Treatment

The medium to be treated may be pre-treated before exposed to the method described elsewhere herein.

A pre-treatment may be an electrochemical pre-treatment process for removing organic compounds, microorganisms and/or inorganic compounds, the pre-treatment process comprises directing the medium to an electrochemical cell wherein alternating current is applied before exposing the medium to the method described elsewhere herein. Pre-treatment in the form of an electrochemical treatment with alternating current may be one as described in WO0226635 and the related US2004/0020861.

A pre-treatment of the medium to be treated according to the method described herein may include a mechanical pre-treatment process for obtaining a medium comprising particles and/or compounds to be removed, the pre-treatment process comprises,

providing a non-liquid medium comprising solid pieces of the non-liquid medium,

optionally treating the pieces of non-liquid medium to decreasing the size of the pieces and/or grinding the pieces,

mixing the pieces of a non-liquid medium with a liquid, where the mixing causes particles and/or compounds to be removed from the non-liquid medium to be suspended in the liquid,

preparing an extract from the liquid mixed with the non-liquid medium and hereby obtaining a liquid medium comprising particles and/or compounds to be removed, the liquid medium is then exposed to the method described elsewhere herein.

With the pre-treatment process described above, slags from e.g. burning solid waste and cineration or other types of slags, is crushed and mixed with a liquid. This liquid can be sulphuric acid or nitric acid. Metal from the slags e.g. cadmium and zinc can be obtained in the liquid part of the suspension. This liquid part is treated by the method described elsewhere herein to remove or recover the cadmium.

A pre-treatment may also be in the form of preparing a suspension, dissolve or preparation of an extraction of a solid or viscous medium before treatment in the apparatus.

A pre-treatment can also be separation e.g. through a laminated separator or filtration.

A pre-treatment system of some of the mentioned may be incorporated into the apparatus.

### Use of Apparatus

An aspect of the invention is the use of the treatment apparatus as described elsewhere herein.

In an embodiment the treatment apparatus is used to treat ground water to remove metal. The metal may be selected from the group of nickel (Ni), arsenic (As) and vanadium (V). The metal may further be recovered in accordance with the processes as described herein.

In another embodiment the treatment apparatus is used to treat process water to remove metal. The types of metal are described elsewhere herein.

When liquid is treated in the treatment apparatus of the present invention, bacteria that may be present in the liquid are killed by the treatment. At least 50% of the bacteria in the liquid to be treated can be killed by the treatment, such as at least 60%, e.g. at least 70%, such as at least 80%, e.g. at least 90%, such as at least 95%, e.g. at least 99%, such as substantially 100%.

When the bacteria of the treated liquid are killed, there is no need for an UV (ultra-violet) treatment. Especially when treating water to be used as drinking water for mammals e.g. animals and/or humans it is important to remove bacteria from the water. Drinking water treated in the apparatus described herein need not be UV treated.

Water to be treated can also be any kind of clear water. By clear water is understood water that by the human eye seems to be pure as it does not contain any coloured compounds or is cloudy or contains any visible particles. The clear water may contain e.g. metal and/or bacteria and/or pathogens as contaminants or impurities. Dependent on the type of contaminants or impurities the water can be further treated in a treatment apparatus described elsewhere herein and which is configured to treat the actual contaminants or impurities.

Waste water of any type can be pre-treated e.g. by filtration to obtain clear water. Any kind of filtration by which it is possible to obtain clear water can be used as a pre-treatment. An example of such pre-treatment to obtain clear water is a GFF-, GFC- and/or GFA-filtration, e.g. combined with a 0.45 μm particle filtration.

A pre-treatment of waste water of any kind can also be a filtration in one or more particle filters and filtration in a sand filter. The particle filtration may be performed by any combination of particle filters with a filtration size decreasing from e.g. 1 cm to 10 μm, 5 μm, 1 μm or 0.45 μm.

Industrial waste water can be treated in the treatment apparatus described herein, preferable the industrial waste water is pre-treated to remove any oil; lubricant e.g. silicone; organic material e.g. BAM; inorganic particles e.g. sand particles; etc if present.

Oil may be removed from a liquid by filtration through rock wool and/or glass wool optionally treated with resin. By using these filtration materials heavy metals can still be obtained in the liquid after the filtration, these heavy metals and other materials too may be removed partly or entirely from the liquid by treatment in an apparatus as described herein.

Organic material can be removed from waste water by the method described in the document WO 0226635, which is hereby incorporated by reference. WO 0226635 describes an electrochemical process and an electrochemical reactor system for cleaning of water, in particular groundwater, contaminated by organic or inorganic substances, such as chlorinated organic substances, aromatic—and aliphatic hydrocarbons and MTBE. The process and system is based on an alternating current (AC unit) is utilised to prevent deposition of insoluble compounds on the electrodes.

Organic material does not need to be removed from a liquid before treating the liquid in an apparatus as described herein. Water with dissolved organic matter of at least 19,000 mikrogram per liter of water can be treated to deposit metals in an apparatus as described herein without any pre-treatment to remove the organic material.

Also BAM can be removed by a pre-treatment as described in WO 0226635.

Waste water can also be wash water e.g. from cars (passenger car, lorry, bus etc) washing systems, laundries or aeroplane washing systems. Wash water may first be pre-treated to remove soap material and organic compounds e.g. by the method described in WO 0226635, and then the water is treated according to the method described herein.

Treatment systems can be incorporated in household articles or industry articles e.g. washing machines, automatic dishwashers etc. to treat the waste water by the process described in WO 0226635 followed by the process described elsewhere herein. Thus treatment systems as described in WO 0226635 together with the treatment system as described herein can be incorporated in the household or industry articles.

When drilling for oil and gas, the cuttings and drilling mud may include different contaminants, some of these being metals. Metal is released from the solid material in the processing at the oil-and gas drilling platform or at further processing on sea or on land, and where this metal is transferred to a liquid, this liquid can be treated in an apparatus of the present invention to remove contaminants as described elsewhere herein. The liquid can be treated in an apparatus as described herein on a platform, on a work boat receiving the cuttings and/or drilling mud from the platform, or on land when the cuttings and/or drilling mud has been transported to land.

With an apparatus of about 0.2 m³ (e.g. 75*63*44 cm as length*width*height), it may be possible to treat at least 1 m³ of liquid per hour, such as at least 2 m³ per hour, e.g. at least 3 m³ per hour, such as at least 4 m³ per hour, e.g. at least 5 m³ per hour, such as at least 6 m³ per hour, e.g. at least 7 m³ per hour, such as at least 8 m³ per hour, e.g. at least 9 m³ per hour, such as at least 10 m³ per hour, e.g. at least 11 m³ per hour, such as at least 12 m³ per hour, e.g. at least 13 m³ per hour, such as at least 14 m³ per hour, e.g. at least 15 m³ per hour, such as at least 20 m³ per hour, e.g. at least 25 m³ per hour.

### DETAILED DESCRIPTION OF THE DRAWINGS

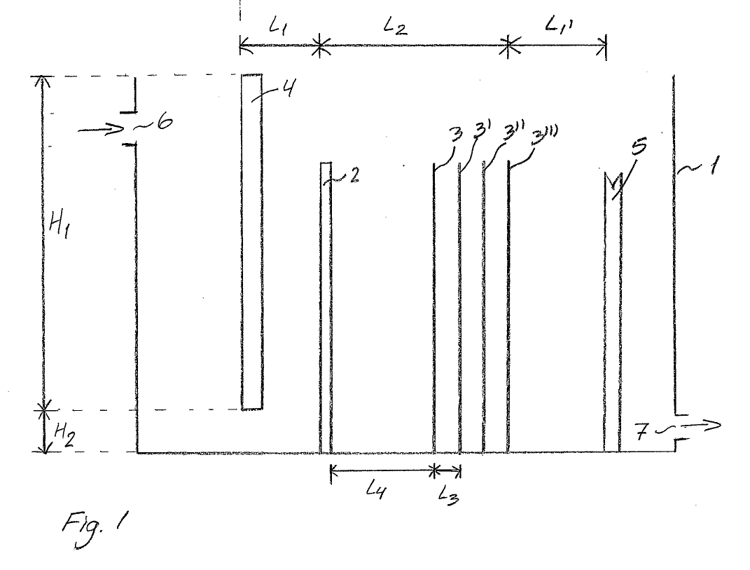

FIG. 1. Side view of an apparatus according to the present invention. 1. The container. 2. A first electrode, preferred in the form of one or more anodes, one anode may constitute a row of anode elements. 3, 3′, 3″, 3′″. At least one second electrode, preferred in the form of one or more cathodes. Here exemplified by four cathodes, but the number may vary from 1 to many. 4. First plate for regulation of the flow direction of the liquid. Liquid passes the first plate at the bottom of the container. The first plate can be moved in vertical direction to increase or decrease the flow rate of the liquid passing through the apparatus. 5. Second plate for regulation of the flow direction of the liquid. Liquid passes the second plate at the upper position of the plate. The second plate can be moved in vertical direction. For lowering the upper position of the second plate a plate with a lower height can be inserted to decrease the surface level of the liquid in the container, a higher plate can be inserted to increase the surface level of the liquid in the container. The height of the second plate is preferably positioned at a level where the second electrodes are covered by the liquid in the container when the apparatus is in function. 6. A first opening, here shown as an inlet. 7. A second opening, here shown as an outlet. The first plate (4) and second plate (5) may be optional. The inlet (6) and outlet (7) may be positioned anywhere in each end of the container (1).

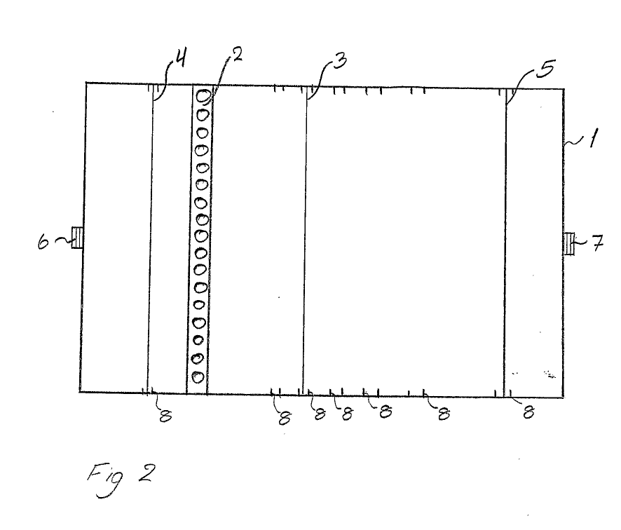

FIG. 2. Top view of the apparatus according to the present invention. 1. The container. 2. Bars of first electrodes positioned in mounting means for keeping the first electrodes in the proper location. 3. Second electrode, here exemplified by only one mat of a second electrode, but the number can be higher. 4. First plate for regulation of the flow direction of the liquid. The first plate is positioned in a groove or plate rail in each side of the container. 5. Second plate for regulation of the flow direction of the liquid. 6. The inlet. 7. The outlet. 8 . Grooves or plate rails for positioning the first plate, second plate and second electrodes in the container. In the figure five grooves are shown for the positioning of second plates, more or less grooves may be located in the container. Frames may be used to improve the handling of the second electrodes. The first electrode(s) may also be positioned in a frame, and the first electrodes or the frame including the first electrodes may be positioned in grooves.

FIG. 3. Amount of water passing through an apparatus according to the present invention with or without a 0.5 cm thick syntepon mat metallised with copper (nano thickness) as a second electrode. In the Figure “u filter” (broken line) shows the amount of water passing through an apparatus of 0.2 m³ (75*63*44 cm as length*width*height) without a second electrode, “m filter” (unbroken line) shows the amount of water passing through the apparatus with a second electrode in the form of 0.5 cm of syntepon metallised with copper. The Y-axis indicate the volume of water passing through the apparatus (litre/hour). The X-axis is the setting of the pump which is pumping the water through the apparatus. The max setting of the pump is 9.9 (not used in the test), which correlates to pumping about 9000 l/hour at a head of 1 meter. The second electrode material resulted in no or only very small pressure drop at a pumping effect of less than 800 litre water per hour per m², which correlates to a pump setting of 1 and below 1. At a pump setting of 1,782 l/hour of water is pumped through the apparatus without a second electrode and 642 l/hour of water is pumped through the apparatus with a second electrode.

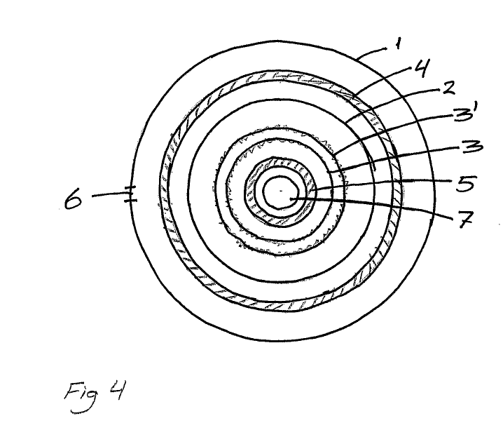

FIG. 4. Top view of a cylinder-shaped apparatus according to the present invention. 1. The container. 2. First electrodes. 3. Second electrode, here exemplified by two mats of a second electrode. 4. First plate. 5. Second plate. 6. Inlet positioned in the upper part of the wall of the container. 7. Outlet in the bottom of the container.

### EXAMPLES

### Example 1

### Retention Time

The retention time within the second electrode is important for deposition to occur and is depending on different characteristics of the apparatus and the flow of the medium to be treated. Table 1 show some examples of an apparatus according to the present invention.

TABLE 1
Retention time

| | Example 1 | | Example 2 | |
|---|---|---|---|---|
| The container | | | | |
| Width | 40 | cm | 60 | cm |
| Height of liquid | 40 | cm | 50 | cm |
| Distance inlet to outlet | 60 | cm | 55 | cm |
| The second electrode | | | | |
| Distance from the first | 10 | cm | 20 | cm |
| electrode to the last of | | | | |
| the second electrodes | | | | |
| Useable height of electrode | 32 | cm | 42 | cm |
| Useable width of electrode | 32 | cm | 52 | cm |
| Thickness of each electrode | 0.5 | cm | 0.5 | cm |
| Total thickness of electrodes | 1 | cm | 2 | cm |
| Inlet | | | | |
| Inlet volume | 10 l/min = 0.6 m³/hr | | 15 l/min = 0.9 m³/hr | |
| Design characteristics | | | | |
| Volume of container | 96 | l | 165 | l |
| Volume of reactor (volume | 16 | l | 60 | l |
| between first electrode and | | | | |
| the last of the second | | | | |
| electrodes) | | | | |
| Volume of electrode material | 0.51 | l | 2.18 | l |
| Retention time | | | | |
| Average time in the container | 9.6 | min | 11 | min |

| | | |
|---|---|---|
| Average time in the reactor | 1.6 min = 96 sek | 4 min = 240 sek |
| Average time within the | 0.05 min = 3 sek | 0.15 min = 9 sek |
| second electrode | | |

### Example 2

### Standard Electrode Reduction Potentials

The electrode reduction potential of a compound to be depositioned onto a second electrode is of importance when determining the potential difference to be obtained over the electrodes of the apparatus.

TABLE 2
Standard electrode reduction potential

| Electrode reaction | Reduction potential, volts |
|---|---|
| Cr²⁺ + 2e⁻ → Cr | −0.91 |
| Zn²⁺ + 2e⁻ → Zn | −0.763 |
| Cr³⁺ + 3e⁻ → Cr | −0.74 |
| PbCrO₄ + 2e⁻ → Pb + CrO₄²⁻ | −0.499 |
| Cr³⁺ + e⁻ → Cr²⁺ | −0.41 |
| Ni²⁺ + 2e⁻ → Ni | −0.25 |
| Pb²⁺ + 2e⁻ → Pb | −0.126 |
| Cu²⁺ + 2e⁻ → Cu | +0.337 |

### Example 3

In FIG. 1 an embodiment of the present invention is shown in a side view, with the following features: 1: Container. 2: First electrodes. 3,3′, 3″, 3′″: Second electrodes. 4: First plate. 5: Second plate. 6: First opening, here shown as an inlet. 7: Second opening, here shown as an outlet. L₁, L_{1′}, L₂, L₃, L₄, H₁ and H₂ indicates the marked distances. L₁ is the distance between the first plate and the first electrode; L_{1′} is the distance between the last of the second electrodes and the second plate; L₂ is the distance between the first plate and the last of the second electrodes; L₃ is the distance between two electrodes; L₄ is the distance between the first electrode and the first of the second electrodes; H₁ is the height of the first plate; and H₂ is the distance from the first plate to the bottom of the container.

The proportions between the distances may be:

H₁=3H₂

L₁=L₁

L₁>3H₂

L₃<L₄

### Example 4

In an apparatus as described herein water with 100 mg/L nickel was treated. The fiber material of the second electrode was 10*10 cm (frame dimension). The total volume of the apparatus was about 2 L. The distance between the anode and the cathode was between 1 and 5 cM. The amount of metal deposited depended on the thickness of the second electrode:

4 cm resulted in deposition of 70% of the metal,

8 cm resulted in deposition of 80% of the metal,

12 cm resulted in deposition of 90% of the metal.

With a thicker second electrode e.g. of about 16 cm nearly 100% of the metal is expected to be deposited on the second electrode.

### Example 5

Water has been treated in an apparatus with the following data:

Length, width and height of the apparatus: 74 cM, 56 cM and 50 cM, respectively.

Inlet located 39 cM above bottom level. The inlet was % inch in diameter.

Distance from inlet to first plate: 20 cM.

Distance beneath first plate: 2 cM.

Distance from inlet to cathode: 35 cM.

Second plate 40 cM height. Thus the water level of the apparatus was also about 40 cM.

Distance from second plate to outlet 7 cm.

Outlet located close to the bottom. The inlet was % inch in diameter.

Distance between anode and cathode: 25 mM.

The anode was a platinum thread with a diameter of about 0.5 mM. A wire of at least 220 cM was mounted on a frame in a meander structure with substantial sharp corners resulting in 7 wires of about 28 cm with an internal distance of 3.5 cM between two wires.

Dimension of fiber material (cathode) 0.4 dM * 3.4 dM * 3,45 dM (total volume 4.7 L). The fiber was made of polyethylene, each fiber was about 30-32 μM thick. The fiber material was surface treated with silver with a thickness of 1-10 silver atoms in thickness. The fiber material was metallised syntepon.

The frame with the anode and a frame with the cathode was together located in a cassette, 56 cM in width and at least 40 cM high, and 18 cM in depth.

Velocity of water through the apparatus: 6 L/h.

Retention time within the cathode: about 45 minutes.

Potential difference: 0.9 V.

Resistance: 0.06 A.

The water was passed one time through the apparatus.

The amount of different metals in the water before treatment is listed in table 3. It is expected that the concentration of most of the metals within the treated water are reduced essentially. The analysis of the treated water is to be obtained. Heavy deposition of metal has been observed on the cathode, especially silver, copper, zinc and aluminum are expected to be deposited on the cathode.

TABLE 3
Content of metals in water before treatment in an
apparatus according to the present invention.

| | | |
|---|---|---|
| Aluminium, Al | 3000 | μg/l |
| Antimony, Sb | 0.031 | μg/l |
| Arsenic, As | <2 | μg/l |
| Barium, Ba | 700 | μg/l |
| Beryllium, Be | 0.3 | μg/l |
| Lead, Pb | 3200 | μg/l |
| Boron, B | 500000 | μg/l |
| Bromine, Br | 270000 | μg/l |
| Cerium, Ce | 0.4 | μg/l |
| Caesium, Cs | 1.5 | μg/l |
| Dysprosium, Dy | <0.1 | μg/l |
| Erbium, Er | <0.1 | μg/l |
| Europium, Eu | 0.1 | μg/l |
| Phosphorous, P | 130000 | μg/l |
| Gadolinium, Gd | <0.1 | μg/l |
| Gallium, Ga | 3 | μg/l |
| Germanium, Ge | <10 | μg/l |
| Gold, Au | <0.5 | μg/l |
| Hafnium, Hf | 0.4 | μg/l |
| Holmium, Ho | <0.1 | μg/l |
| Iridium, Ir | <0.1 | μg/l |
| Iodine, I | 500 | μg/l |
| Iron, Fe | 3400 | μg/l |
| Cadmium, Cd | 8.5 | μg/l |
| Calcium, Ca | 37000 | μg/l |
| Potassium, K | 4000000 | μg/l |
| Silicon, Si | 5000000 | μg/l |
| Cobalt, Co | 70 | μg/l |
| Copper, Cu | 14000 | μg/l |
| Chromium, Cr | 200 | μg/l |
| Mercury, Hg | <0.5 | μg/l |
| Lanthanum, La | 0.8 | μg/l |
| Lithium, Li | 34000 | μg/l |
| Lutetium, Lu | <0.1 | μg/l |
| Magnesium, Mg | 200 | μg/l |
| Manganese, Mn | 600 | μg/l |
| Molybdenum, Mo | 700 | μg/l |
| Sodium, Na | 9000000 | μg/l |
| Neodymium, Nd | 0.6 | μg/l |
| Niobium, Nb | 0.4 | μg/l |
| Nickel, Ni | 100 | μg/l |
| Osmium, Os | <0.1 | μg/l |
| Palladium, Pd | 5 | μg/l |
| Platinum, Pt | 0.5 | μg/l |
| Praseodymium, Pr | 0.2 | μg/l |
| Rhenium, Re | <0.1 | μg/l |
| Rhodium, Rh | <0.1 | μg/l |
| Rubidium, Rb | 300 | μg/l |
| Ruthenium, Ru | <0.1 | μg/l |
| Samarium, Sm | 2.5 | μg/l |
| Selenium, Se | <10 | μg/l |
| Silver, Ag | 18000 | μg/l |
| Scandium, Sc | 0.1 | μg/l |
| Strontium, Sr | 270 | μg/l |
| Sulphur, S | 220000 | μg/l |
| Tantalum, Ta | 1 | μg/l |
| Tellurium, Te | <1 | μg/l |
| Thallium, Tl | 0.09 | μg/l |
| Tin, Sn | 730 | μg/l |
| Terbium, Tb | <0.1 | μg/l |
| Titanium, Ti | 320 | μg/l |
| Thorium, Th | 0.15 | μg/l |
| Thulium, Tm | <0.1 | μg/l |
| Uranium, U | <0.1 | μg/l |
| Vanadium, V | 40 | μg/l |
| Bismuth, Bi | 15 | μg/l |
| Tungsten, W | 100 | μg/l |
| Ytterbium, Yb | <0.1 | μg/l |
| Yttrium, Y | 0.4 | μg/l |
| Zinc, Zn | 20000 | μg/l |
| Zirconium, Zr | 7 | μg/l |

1-37. (canceled)

38. The medium treatment apparatus, said apparatus comprising
i. a container with at least one first opening and at least one second opening, where one of said first opening and second opening is positioned in the apparatus to direct medium into the treatment apparatus and the other of said first opening and second opening is positioned in the apparatus to direct medium out of the treatment apparatus,
ii. at least one first electrode comprising a first conductive non-metal material or a first metal and said first conductive non-metal material or first metal is optionally surface treated with a precious metal,
iii. at least one second electrode comprising a support material, wherein said support material is at least partly coated with a second metal or said support material comprises a second conductive non-metal material optionally at least partly coated with a second metal, and
iv. wherein said at least one first electrode is located closest to said first opening and said at least one second electrode is located closest to said second opening, and
v. wherein there is a potential difference between said at least one first electrode and said at least one second electrode to effect electrochemical deposition on one of said at least one first or second electrode.

39. The treatment apparatus according to claim 38, where said at least one first opening is at least one inlet, and said at least one second opening is at least one outlet.

40. The treatment apparatus according to claim 38, further comprising a first plate wherein said first plate is positioned between said at least one first opening and said at least one first electrode.

41. The treatment apparatus according to claim 38, further comprising a second plate and where said second plate is positioned between said at least second electrode and said at least one second opening.

42. The treatment apparatus according to claim 38, wherein said first metal is selected from the group of titanium, aluminum, steel, and platinum.

43. The treatment apparatus according to claim 38, wherein said first and/or second conductive non-metal material is selected from the group of ceramic materials, non-conductive polymers or conductive polymers.

44. The treatment apparatus according to claim 38, wherein said precious metal is of platinum.

45. The treatment apparatus according to claim 38, wherein the entire of said first electrode is made of platinum.

46. The treatment apparatus according to claim 38, wherein said support material comprises a ceramic material or at least one polymer.

47. The treatment apparatus according to claim 38, wherein said support material is metallized with silver, copper or nickel.

48. The treatment apparatus according claim 38, wherein the volume between said at least one first electrode and said at least one second electrode is occupied only by the medium to be treated in the apparatus when the apparatus is in function.

49. The treatment apparatus according to claim 38, wherein the number of said second electrode is 2, 3, 4, 5 or 6.

50. A process for treating a medium, said process comprising
i. providing a quantity or a continuous flow of a medium to be treated, said medium includes particles and/or compounds to be removed partly or fully from said medium,
ii. directing an amount of said medium to be treated to a treatment apparatus as specified in claim 38,
iii. directing said medium past at least one first electrode,
iv. directing said medium past at least one second electrode, where a potential difference is established between said at least one first electrode and said at least one second electrode, and where said particles and/or compounds will bind to said at least one first electrode or said at least one second electrode, hereby obtaining treated medium when said medium has passed said at least one second electrode,
v. directing said treated medium to an outlet of said apparatus.

51. A process for recovering particles and/or compounds from a medium, said process comprising
i. providing a medium to be treated, said medium includes particles and/or compounds to be removed partly or fully from said medium,
ii. directing said medium to be treated through an electrochemical cell or to a treatment apparatus as specified in claim 38, by first directing said medium through at least one first electrode, and then directing said medium past at least one second electrode,
iii. maintaining a potential difference between said at least one first electrode and said at least one second electrode to effect electrochemical deposition of said particles and/or compounds on said at least one second electrode,
iv. recovering a solution partly or fully released from said particles and/or compounds, and
v. obtaining at least one second electrode with deposited particles and/or compounds, and
vi. recovering said deposited particles and/or compounds by heating said at least one second electrode to a temperature where said at least one second electrode is burned away.

52. The process according to claim 50, further including an electrochemical pre-treatment process for removing organic compounds, microorganisms and/or inorganic compounds, said pre-treatment process comprises prior to step ii,
directing said medium to an electrochemical cell wherein alternating current is applied.

53. The process according to claim 50, further including a mechanical pre-treatment process for obtaining a liquid comprising particles and/or compounds to be removed, said mechanical pre-treatment process comprises prior to step i,
providing a non-liquid medium comprising solid pieces of the non-liquid medium,
optionally treating the pieces of non-liquid medium by decreasing the size of said pieces and/or grinding said pieces,
mixing said pieces of a non-liquid medium with a liquid, where the mixing causes at least particles and/or compounds to be removed from said non-liquid medium to be partly or fully suspended in said liquid,
preparing an extract from said liquid mixed with said non-liquid medium and hereby obtaining a liquid medium comprising particles and/or compounds to be removed.

54. The process according to claim 50, wherein said first electrode comprises a first metal selected from the group of titanium, aluminum, steel, platinum.

55. The process according to claim 50, wherein said second electrode comprises a support material selected from the group of ceramic materials, non-conductive polymers and conductive polymers.

56. The process according to claim 50, wherein the volume between said at least one first electrode and said at least one second electrode is occupied only by the medium to be treated in the apparatus.

57. The process according to claim 50, wherein the number of said second electrode is 2, 3, 4, 5 or 6.

58. The process according to claim 57, wherein said 2, 3, 4, 5 or 6 electrodes are positioned at different distances from said first electrode and different particles and/or compounds to be removed are deposited on different electrodes of said second electrodes in a manner that all particles and/or compounds of one type are deposited on the same electrode.

59. The process according to claim 50 for treating ground water and/or process water to remove metal.

60. The process according to claim 59, wherein said metal is selected from the group of nickel, arsenic and vanadium.
